(19) United States
(12) Patent Application Publication
(10) Pub. No.: US 2012/0114969 A1
(43) Pub. Date: May 10, 2012

(54) Anticorrosion Mirror, Method for Producing Same, and Uses Thereof in Solor Energy

(75) Inventor: Samuel Stremsdoerfer, Dardilly (FR)

(73) Assignee: JET METAL TECHNOLOGIES, Champagne-au-Mont-d'Or (FR)

(21) Appl. No.: 13/256,319

(22) PCT Filed: Mar. 15, 2010
(86) PCT No.: PCT/EP2010/053270

§ 371 Date: Dec. 20, 2011

(30) Foreign Application Priority Data
Mar. 13, 2009 (FR) 0951621

(51) Int. Cl. B32B 17/06; B05D 5/06

(52) U.S. Cl. 428/630; 427/168

(57) ABSTRACT

The present invention relates to a corrosion-resistant “all-metal” mirror, including: a glass substrate; a silver coating with a thickness e_{Ag} deposited on at least one surface of the substrate by a non-electrolytic metallization that comprises spraying, onto the substrate surface, at least one aerosol containing silver in cation form (oxidizer) and at least one reducing agent capable of converting the silver cation into metal; at least one protective layer (C) containing at least one metal other than silver and deposited on the silver coating. The protective layer has a thickness eₘ such that 0.3 e_{Ag}≦e_{M}≦5 e_{Ag}, and is obtained by a non-electrolytic metallization of the silver coating being carried out by spraying, onto the silver coating, at least one aerosol containing at least one metal, other than silver, in cation form (oxidizer), and at least one reducing agent capable of converting the metal cation into metal.

### TECHNICAL FIELD

The technical field of the invention is that of mirrors.

Mirrors have numerous applications, among which there may be mentioned for example interior mirrors for household use, such as are to be found in bathrooms, or mirrors for the car industry, such as rear-view mirrors, etc.

There are also other applications of mirrors, and in particular use thereof for collecting solar energy.

These differences in the applications of mirrors account for the different performance levels required in terms of strength and reflectivity. In fact, solar mirrors are subjected to very aggressive climatic and environmental conditions (sand, water, salt, heat, UV radiation, etc.), causing their premature corrosion. Moreover, solar mirrors must have very good reflectivity, in order to provide optimum efficiency of energy collection.

The present invention relates to a corrosion-resistant mirror and a method for producing such a mirror, in particular by non-electrolytic metallization.

### PRIOR ART—TECHNICAL PROBLEM

The manufacture of mirrors by silvering of glass is one of the oldest industrial applications of metallization, which developed considerably during the last century.

In fact, at the beginning of the twentieth century, mirrors were produced electrolytically (RUOLZ and ELKINGTON method). Using this technique, a first deposit of silver was made on the surface of the glass by means of an external current source and then a layer of copper was deposited on the silver by the same method. The layer of copper was said to be protective and the combination thereof with several layers of lead paint conferred anticorrosion properties on the mirror thus obtained. However, the metallic coatings obtained were of considerable thickness, between 350 and 500 μm, and production took more than one hour under industrial conditions. The electrolytic metallization was therefore both time-consuming and energy-intensive. It was also complex, as it required the use of relatively sophisticated equipment.

An alternative to this electrolytic technique was the chemical silvering of glass, which originally consisted of utilizing gravity to precipitate silver by dipping in baths of metal solutions containing a silver salt, a reducing agent and a complexing agent. Then a layer of copper was also produced by the same method of dipping and finally one or more layer(s) of lead paint was/were applied to protect the mirror against corrosion and ageing. These metallization steps involved considerable expenditure in energy, time and water and moreover had many drawbacks, such as instability of the deposition baths, impossibility of metallizing substrate surfaces of complex (non-planar) form and of obtaining localized deposits, etc.

Later, and as can be seen for example from the British patent application dating from 1978 published under number GB 1499339, metallization by dipping in baths of metal solutions was replaced by spraying of said solutions on the substrate surface.

Nevertheless, these techniques of chemical silvering have many drawbacks, in particular:
the products used are dangerous, corrosive, toxic and flammable (in particular caustic soda, sulphuric acid and the formaldehyde-based reducing agent),
the kinetics of deposition is limited to 20 pm of thickness per hour,
there is a technical difficulty connected with simultaneous co-deposition of different metals,
there is a limited range of metals or alloys that can be deposited,
the adherence of the metal films deposited leaves room for improvement.

Moreover, the anticorrosion character of the mirrors obtained by the methods described above was provided by a combination of a layer of copper and layers of lead paint, which have the drawback of being toxic.

More recently, in the area of corrosion-resistant mirrors, patent applications WO 2005/090256 and U.S. 2001/0033935 by the company Glaverbel describe mirrors without a layer of copper and without lead paint, for which the property of corrosion resistance is provided by organic (lead-free) finishing paints, which are applied on the silver coating. In this technique, the anticorrosion properties were improved by a so-called “passivation” treatment of the silvered layer with solutions of metal salts, for example solutions of palladium chloride PdCl₂, of PdCl₂/SnCl₂ mixtures, solutions of zirconium sulphate Zr(SO₄)₂, etc. This solution proves to be unsatisfactory for the area of solar mirrors subjected to very harsh climatic conditions. In fact, the organic paints of these mirrors constitute the only anticorrosion barrier, and UV radiation degrades organic paints. During degradation, charges are created on the surface of the paints, supporting the reaction of oxidation of the paints. The result is that the anticorrosion paint actually becomes an accelerator of corrosion. In practice, such mirrors deteriorate rapidly: their reflectivity decreases after a few years, whereas mirror manufacturers aim to supply mirrors that provide good performance for at least 15 years. This difference between the quality supplied and the quality required means that manufacturers must regularly replace the mirrors, which is very expensive, especially in the case of installations for collecting solar energy, which comprise hundreds of mirrors. The few innovations that have been made in this field are oriented rather to formulations of anticorrosion paints that are increasingly sophisticated and therefore more and more expensive. Moreover, the existing systems use two or three layers of paint, which is inconvenient from an industrial standpoint.

Furthermore, to overcome the problems associated with the metallization of substrates by chemical means in general, patent applications FR-A-2 763 962 and WO 2008/062070 A1 disclose a non-electrolytic method for metallization of a substrate by spraying an aerosol containing a metal in cationic form (oxidizer) and a reducing agent, which are brought in contact, either beforehand by simultaneous spraying of two aerosols each containing the oxidizer and the reducing agent respectively, or on the substrate surface by alternately spraying an aerosol containing the oxidizer and an aerosol containing the reducing agent. However, these documents do not solve the problem of accelerated corrosion of mirrors for solar applications.

Objectives

One of the main objectives of the present invention is therefore to supply a mirror that is corrosion-resistant in an aggressive environment (UV radiation, salt, humidity, thermal shocks), and moreover displays sufficient reflectivity for solar applications, i.e. reflectivity advantageously greater than or equal to 85%, preferably greater than or equal to 90%.

Moreover, the mirror of the invention should be corrosion-resistant, even in the absence of anticorrosion paint.

Furthermore, the mirror of the invention should be able to offer excellent reflectivity while having a thinner silver coating than is deposited conventionally for this application.

Finally, the minor of the invention should be based on common, simple and inexpensive materials, the formulation of which is easy to use.

Another objective of the present invention is to propose an industrial method of manufacture of said mirrors by a non-electrolytic method, by spraying one or more oxidizing and reducing solution(s), satisfying at least one of the following objectives:
the method should promote adhesion of the metallic film to the substrate surface,
the method should make it possible to control the regularity of thicknesses regardless of substrate shape, even if it is complex,
the method should be “clean”, i.e. should use solutions of low toxicity or non-toxic or in very small amounts and permit recycling of the effluents from the method,
the method should provide flexibility for the industrial installations employing it: simplified equipment, omission of manufacturing steps, increased productivity, etc.

### BRIEF DESCRIPTION OF THE INVENTION

Now, after much research, the applicant discovered that the introduction of at least one protective layer based on a metal other than silver, on the silver coating, by a non-electrolytic metallizing method ensuring a particular thickness ratio, gives a significant increase in corrosion resistance of the minor in aggressive environments, without needing to add layers of organic anticorrosion paint.

Accordingly, the present invention relates to an “all-metal” corrosion-resistant minor comprising:
a glass substrate,
a silver coating, of thickness e_{Ag}, deposited on at least one face of the substrate, by non-electrolytic metallization consisting of spraying, onto said face of the substrate, at least one aerosol containing silver in cationic form (oxidizer) and at least one reducing agent, capable of converting the silver cation into metal,
at least one protective layer, based on at least one metal other than silver, deposited on the silver coating,
characterized
(i) in that the silver coating has a thickness e_{Ag} between 30 and 150 nm, preferably between 50 and 120 nm,
(ii) and in that said protective layer:
   has a thickness e_{M} such that: 0.3 e_{Ag}≦e_{M}≦5 e_{Ag}, and
   it is obtained by non-electrolytic metallization of the silver coating, said metallization being carried out by spraying, on the silver coating, at least one aerosol containing at least one metal, other than silver, in cationic form (oxidizer), and at least one reducing agent capable of converting the metal cation into metal,
   it is a monolayer of a metal, other than silver, in which the metal is selected from the following group: Ni, Zn, Co, Fe, Mn, Ti, Pd, Sn, Al, and binary and ternary alloys based on Ni, Co, Zn, Fe, Cu and B.

The present invention also relates to a non-electrolytic method for producing an “all-metal” corrosion-resistant mirror comprising:
a step of sensitizing the surface of a glass substrate by spraying a sensitizing solution, preferably based on stannous chloride,
optionally rinsing,
optionally a step of activation of the surface of the glass substrate by spraying an activating solution, preferably based on palladium chloride,
optionally rinsing,
a step of silvering by spraying, on at least one substrate surface, at least one aerosol containing silver in cationic form (oxidizer) and at least one reducing agent, capable of converting the silver cation into metal, the silver coating having a thickness e_{Ag} between 30 and 150 nm, preferably between 50 and 120 nm,
optionally rinsing,
optionally drying,
a step of producing at least one protective layer, based on at least one metal other than silver, of thickness between 0.3 and 5 times the thickness of the silver coating produced during the silvering step, and by spraying, on the silver-coated substrate surface, at least one aerosol containing at least one metal, other than silver, in cationic form (oxidizer) and at least one reducing agent, capable of converting the metal cation into metal, said protective layer:
   having a thickness e_{M} such that: 0.3 e_{Ag}≦e_{M}≦5 e_{Ag}, and
   being obtained by non-electrolytic metallization of the silver coating, this metallization being carried out by spraying, on the silver coating, at least one aerosol containing at least one metal, other than silver, in cationic form (oxidizer), and at least one reducing agent capable of converting the metal cation into metal,
   and being a monolayer of metal other than silver, in which the metal is selected from the following group: Ni, Zn, Co, Fe, Mn, Ti, Pd, Sn, Al, and binary and ternary alloys based on Ni, Co, Zn, Fe, Cu and B.

Finally, the present application relates to the use of an “all-metal” corrosion-resistant mirror as defined previously or obtained by the method described above for application thereof in solar energy collection.

Definitions

Within the meaning of the present invention, the term “all-metal” means that the role of anticorrosion barrier is performed by at least one protective layer based on at least one metal, and not only by layers of paint.

The term “corrosion-resistant” will be understood, within the meaning of the present invention, for example on the basis of the results of the CASS test defined later in the description.

By “aerosol” is meant for example a mist of droplets smaller than 100 μm, preferably smaller than 60 μm, and even more preferably from 0.1 to 50 μm, that is produced by nebulizing and/or spraying solution(s) and/or dispersion(s).

The term “non-electrolytic metallization of said face of the substrate, by spraying of at least one aerosol . . .” in particular relates to the method described in the international patent application published under number WO 2008/062070 and in French patent FR 2 763 962.

By “at least one aerosol containing at least one metal, other than silver, in cationic form (oxidizer) and at least one reducing agent” is meant that it is e.g.:
either a single solution simultaneously containing one or more oxidizer(s) and one or more reducing agent(s),
or two solutions: the first containing one or more oxidizer(s) and the second containing one or more reducing agent(s),
or a plurality of solutions, each containing either one or more oxidizer(s), or one or more reducing agent(s), provided there is at least one oxidizing solution and at least one reducing solution.

Within the meaning of the present invention, the term “at least one reducing agent, capable of converting the metal cation into metal” means for example that the reducing agent must be strong enough to reduce the metal cation to metal, i.e. that the standard redox potential of the redox couple of the reducing agent must be less than that of the redox couple of the oxidizer (gamma rule).

In the present invention, terms in the singular can also signify the same terms in the plural.

### DETAILED DESCRIPTION OF THE INVENTION

Minor:

According to one embodiment of the invention, the silver coating has a thickness e_{Ag} between 30 and 150 nm, preferably between 50 and 120 nm.

The thickness e_{M} of the protective layer is such that: 0.3 e_{Ag}≦e_{M}≦5 e_{Ag}. In fact, the limits of the range are justified in particular by problems of feasibility of the deposits and economic advantage. On the one hand, above 5 e_{Ag}, no extra quality is supplied to the protective layer, which makes the mirror heavier and it becomes expensive. On the other hand, below 0.3 e_{Ag} the coating cannot be made by the method of the invention. Optimum quality/feasibility/economy is achieved, depending on the type of metal constituting the protective layer, preferably when the thickness e_{M} of the protective layer based on at least one metal is such that: 0.5 e_{Ag}≦e_{M}≦4 e_{Ag}, more preferably 1 e_{Ag}≦e_{M}≦3 e_{Ag} and in particular, e_{M} is such that: 1.5 e_{Ag}≦e_{M}≦2.5 e_{Ag}.

According to a first embodiment of the invention, the protective layer of the mirror is a monolayer of metal other than silver, in which the metal is selected from the following group: Ni, Zn, Co, Fe, Mn, Ti, Pd, Sn, Al, and binary and ternary alloys based on Ni, Co, Zn, Fe, Cu and B. As examples of alloys, there may be mentioned: Ni—B, Ni—B—Zn, Ni—Cu—B, Ni—Co—B, Ni—Fe—B, Ni—Cu—Co—B, Ni—Sn—B etc., which can be produced using a mixture of metal salts.

In this first embodiment, when it is just one metal, it is preferably selected from the following group: Ni, Sn and Zn, and in particular the metal is Ni. When it is a binary or ternary alloy, those that are based on Ni, Co, Zn, Cu and B, and in particular those based on Ni and B are preferred.

According to a second embodiment of the invention, the protective layer of the mirror is a multilayer of metals other than silver, in which:
the metal of each protective layer is selected from the following group: Cu, Ni, Zn, Co, Fe, Mn, Ti, Pd, Sn, Al, and binary and ternary alloys based on Ni, Co, Zn, Fe, Cu and B, and,
the metals or alloys of two successive, contiguous layers are different.

As examples of alloys, there may be mentioned: Ni—B, Ni—B—Zn, Ni—Cu—B, Ni—Co—B, Ni—Fe—B, Ni—Cu—Co—B, Ni—Sn—B etc., which can be produced using a mixture of metal salts.

In this second embodiment, when it is just one metal, each layer is preferably selected from the following group: Cu, Ni, Sn and Zn, and in particular the metal is Ni or Cu. When it is a binary or ternary alloy, those that are based on Ni, Co, Zn, Cu and B, and in particular those based on Ni and B are preferred. It can be alternating layers of a metal or alloy M1 and of a metal or alloy M2: M1/M2/M1, provided that two successive layers of metal or alloy are different, for example Ni—B/Cu/Ni—B or Ni—B/Co—B/Ni—B. Preferably, the succession of layers of different metals or alloys will be: Ni—B/Cu/Ni—B.

Whatever the embodiment of the protective layer based on at least one metal other than silver, at least one layer of the latter can additionally contain hard particles such as diamond, ceramics, carbon nanotubes, metal particles, rare earth oxides, PTFE (polytetrafluoroethylene), graphite, metal oxides and mixtures thereof. Metal particles based on Zn are preferred.

These particles are incorporated in at least one of the oxidizing-reducing solutions to be sprayed at the time of metallization. The particles are thus trapped in the metallic deposit. Incorporation of these particles in the metallic film endows the mirror with particular mechanical, tribological, electrical, functional and aesthetic properties.

Although it does not contribute to the anticorrosion barrier of the minor according to the invention, it is possible in addition to provide at least one finishing layer, applied on the protective layer. In this case, the finishing layer is provided for purposes of mechanical cohesion of the mirror.

According to this particular embodiment of the invention, the finishing layer is a layer of paint selected from the following group of paints: alkyd, acrylic, epoxy. A paint of the alkyd type is preferred.

The mirror according to the invention, whatever its embodiment described above, has a reflectivity greater than 85%, preferably greater than 90%.

According to an embodiment that is particularly suitable for solar application of the mirror, the latter is of parabolic shape.

The corrosion resistance is evaluated by a salt spray test. There are various types of salt sprays: neutral (NSS), acetic acid (AASS) or copper acetic acid (CASS). The latter are defined in international standard ISO 9227-2006, which stipulates the equipment, the reagent and the test procedure of each type of test. This test makes it possible to simulate the conditions of exposure of components to different corrosive atmospheres that may commonly be encountered, such as the seashore, an industrial atmosphere, etc.

The CASS test consists of spraying the mirror, in a chamber at 50° C., with an aqueous solution containing 50 g/l of sodium chloride, 0.26 g/l of anhydrous CuCl₂ with a sufficient amount of glacial acetic acid for the solution to have a pH of between 3.1 and 3.3. The duration of exposure of the mirror to this acidic salt spray can vary. In general, exposure for 120 hours gives an objective assessment of resistance to corrosion and ageing. The test is carried out on glass plates of 10 cm² with freshly cut edges, and after exposure to the acidic salt spray for 120 hours, each plate is weighed and examined with a microscope. The first effect of corrosion can be seen on the edges of the mirror and its extent is measured from the weight change and from the change in measured thickness as well as by visual assessment of surface changes.

The mirror according to the invention has many advantages. Thus, it is resistant to corrosion in aggressive environments (UV radiation, salt, humidity, thermal shocks), owing to the protective layer based on at least one metal. The mirror according to the invention also has improved reflectivity, even when the layer of silver is very thin, owing to the specific thickness ratio between the layer of silver and the protective metallic layer. Moreover, the mirror is easy to make on account of its “lightened” method, using compact industrial equipment, as it does not require the production of a paint multilayer, which involves steps that are long and laborious.

Method:

Sensitizing and Activation:

The optional steps of preliminary sensitizing and/or activation are carried out, in a manner that is known per se, by the application (e.g. spraying, dipping), preferably, of solutes of stannous chloride (SnCl₂) or of an SnSO₄/H₂SO₄/quinol/alcohol solution followed by the application (spraying or dipping), preferably, of a solution of palladium or of silver capable of reacting with the Sn²⁺ to form nucleation sites on the substrate surface, or alternatively a PdSn colloidal solution formed ex situ. For more details, reference may be made for example to “Metal Finishing Guidebook and Directory Issue”, 1996 Metal Finishing publication, pages 354, 356 and 357. H. Narcus “Metallizing of Plastics”, Reinhold Publishing Corporation, 1960, Chapter 2, page 21. F. Lowenheim, “Modern electroplating”, John Wiley & Sons publication, 1974 Chapter 28, page 636.

According to a particular embodiment of the method of the invention, the step of sensitizing the substrate surface is implemented by means of a sensitizing solution based on stannous chloride, for example according to the procedure described in FR-A-2 763 962. In this case, a rinsing step using a rinsing liquid as described below is carried out just after the sensitizing step, without an intermediate step.

According to another particular embodiment of the method of the invention, a step of activation of the substrate surface is implemented by means of an activating solution, in particular of palladium chloride, for example according to the procedure described in FR-A-2 763 962. In this case, a rinsing step using a rinsing liquid as described below is carried out just after the step of activation, without an intermediate step.

Rinsing:

Advantageously, the rinsing steps, i.e. bringing all or part of the substrate surface into contact with one or more source(s) of rinsing liquid, which are performed at various stages of the method of the invention, are carried out by spraying an aerosol of rinsing liquid, preferably water.

Wetting:

A preliminary wetting step, which consists of coating the substrate surface with a liquid film to promote spreading of the oxidizing-reducing solutions, can also be envisaged in the method of the invention.

If steps of sensitizing and/or of activation are provided on the glass substrate, the wetting step is then carried out, according to the procedure described in WO 2008/062070 A1. The wetting step can also replace the steps of sensitizing and/or activation of the substrate.

The wetting liquid is selected from the following group: water, deionized or not, optionally with the addition of one or more anionic, cationic or neutral surfactant(s), an alcoholic solution comprising one or more alcohol(s) (for example isopropanol, ethanol and mixture thereof), and mixtures thereof. Deionized water with the addition of an anionic surfactant and ethanol is in particular selected as the wetting liquid.

In a variant of wetting according to which the wetting liquid is converted into vapour, which is sprayed onto the substrate, on which it condenses, it is preferable for the liquid to be essentially aqueous, for obvious reasons of industrial convenience. The duration of wetting depends on the substrate surface in question and on the flow rate of spraying of the wetting aerosol.

Spraying of Oxidizing-Reducing Solutions:

In the description given below, by “metal solutions” is meant, on the one hand, the solutions of silver for producing the silver coating, and on the other hand, the metal solutions for producing the protective layer, based on at least one metal other than silver.

The oxidizing-reducing solutions used during the step of non-electrolytic metallization are sprayed in the form of aerosols onto the substrate and preferably are obtained from solutions, advantageously aqueous, of one or more oxidizing metal cation(s) and of one or more reducing compound(s). These oxidizing-reducing solutions are preferably obtained by dilution of concentrated stock solutions. The diluent is preferably water.

Thus, according to a preferred embodiment of the invention, the aerosol(s) for nebulizing and/or spraying of solution(s) and/or dispersion(s) are prepared in such a way as to obtain a mist of droplets smaller than 100 μm, preferably smaller than 60 μm, and even more preferably from 0.1 to 50 μm.

In the method according to the invention, the spraying of metal solutions preferably takes place continuously and the substrate is set in motion and is subjected to spraying. In particular, for silver coating, spraying is continuous. When the protective layer, based on at least one metal other than silver, is a metallic deposit based on nickel for example, spraying is intermittent.

In the method of the invention, spraying is carried out so as to give a GSM (grams per square metre) of silver in the range from 0.3 to 1.5 g/m², preferably from 0.78 to 1.2 g/m² and even more preferably of about 1 g/m². Furthermore, spraying is carried out so as to give a GSM for the protective layer, based on at least one metal other than silver, in the range from 0.6 to 3 g/m², preferably from 1.5 to 2.5 g/m² and even more preferably of about 2 g/m². The substrate can be rotated at least partially during the metallization spraying operations.

According to a first spraying method, one or more solution(s) of metal cation(s) and one or more solution(s) of reducing agent(s), in one or more aerosol(s), are sprayed simultaneously and continuously onto the surface to be treated. In this instance, the oxidizing solution and the reducing solution can be mixed just before formation of the spraying aerosol or alternatively by blending an aerosol produced from the oxidizing solution and an aerosol produced from the reducing solution, preferably before coming into contact with the substrate surface to be metallized.

According to a second spraying method, one or more solution(s) of metal cation(s) and then one or more solution(s) of reducing agent(s) are sprayed successively, by means of one or more aerosol(s). In other words, spraying of the oxidizing-reducing solution is carried out by separate spraying operation(s) of one or more solution(s) of one or more metallic oxidizer(s) and of one or more solution(s) of one or more reducing agent(s). This second possibility corresponds to alternate spraying of the reducing solution or solutions and the metal salt or salts.

Within the context of the second spraying method, the combination of several oxidizing metal cations to form a multilayer of different metals or alloys is such that the various salts are, preferably, sprayed separately from the reducing agent, of course, but also separately from one another and successively. It goes without saying that besides the different nature of the metal cations, it is conceivable to use counter-anions that are different from one another.

According to a variant of the spraying step, it is carried out in such a way that the mixture of oxidizer(s) and of reducing agent(s) is metastable and, after spraying of the mixture, the latter is activated so as to initiate the conversion to metal, preferably by contacting with an initiator, advantageously supplied via one or more aerosol(s), before, during or after spraying of the reaction mixture. This variant makes it possible to pre-mix the oxidizer and the reducing agent while delaying their reaction until they coat the substrate surface after spraying. Initiation or activation of the reaction is then achieved by any suitable physical (temperature, UV, etc.) or chemical means.

In addition to the methodological considerations presented above and illustrated below in the examples, it is appropriate to give some more detailed information regarding the products employed in the method according to the invention.

Water appears to be the most suitable solvent, but without excluding the possibility of using organic solvents, for preparing the solutions from which the spraying aerosols will be produced.

The concentrations of metal salts in the oxidizing solutions to be sprayed are from 0.1 g/l to 100 g/l and preferably from 1 to 60 g/l, and the concentrations of metal salts in the stock solutions are from 0.5 g/l to 10³ g/l, or the dilution factor of the stock solutions is from 5 to 500. For producing the silver coating, the metal salt is preferably silver nitrate. For producing the layer of at least one metal other than silver, the metal salts are selected for example from: nickel sulphate, copper sulphate, tin chloride, and mixtures thereof.

The reducing agents are preferably selected from the following compounds: borohydrides, dimethylaminoborane, hydrazine, sodium hypophosphite, formol, lithium aluminium hydride, reducing sugars such as glucose or organic species of the glucose family (i.e. sodium gluconate, methyl-glucosamine, gluconic acid), sodium erythorbate, and mixtures thereof. When formol is selected, it is in very dilute form, the concentration of which does not exceed 0.1 wt. %, in accordance with current regulations. The reducing agent must be selected taking into account the pH and properties required for the metallization film. These routine adjustments are within the capability of a person skilled in the art. The concentrations of reducing agent in the reducing solution to be sprayed are from 0.1 g/l to 100 g/l and preferably from 1 to 60 g/l, and the concentrations of reducing agents in the stock solutions are from 0.5 g/l to 10³ g/l, or the dilution factor of the stock solutions is from 5 to 100.

According to a particular provision of the invention, particles are incorporated in at least one of the oxidizing-reducing solutions to be sprayed at the moment of producing the protective layer, based on at least one metal other than silver. The particles are thus trapped in the metallic layer. These hard particles are for example diamond, ceramics, carbon nanotubes, metal particles, rare earth oxides, PTFE (polytetrafluoroethylene), graphite, metal oxides and mixtures thereof.

Drying:

Drying, which may in particular be included after each rinsing step, consists of removing the rinsing water. It can advantageously be carried out at a temperature from 20 to 40° C. using for example of a pulsed compressed air system at 5 bar/pulsed air at a temperature from 20 to 40° C.

All the embodiments of non-electrolytic metallization within the meaning of the invention are described in more detail in FR-A-2 763 962 and the international patent application published under number WO 2008/062070 A1.

Finishing Layer:

According to the invention, the method further comprises a step of production of a finishing layer, which is the application of a cross-linkable liquid composition on the protective layer, for example a paint or a varnish, preferably a finishing paint. This paint can have a water-soluble or organic base, preferably organic. It is selected from the paints of the following group: alkyds, polyurethanes, epoxies, vinyls, acrylics and mixtures thereof. Preferably, it is selected from the following compounds: epoxies, alkyds and acrylics and, even more preferably, it is an alkyd paint. The cross-linkable liquid finishing composition can be cross-linked by UV or baking and can contain colouring pigments. When the method of the invention envisages the step of the application of a cross-linkable liquid composition, then, preferably, the sub-step of drying of the metallized surface is included during the production of the protective layer based on at least one metal other than silver, by non-electrolytic metallization.

In the method according to the invention, the effluents from the various steps of the method are advantageously treated and recycled to be reused in the method, and to limit the environmental impact.

In the method described above, treatment and recycling of the effluents comprise, in this order, at least the following steps:
collecting the effluents, in particular the wastewater, in a container,
distillation, preferably in an evaporator,
reuse of the distillate in the metallizing method for example as rinsing water or as diluent of the oxidizing-reducing stock solutions, or discharge to the drains.

Preferably, in the method described above, treatment and recycling of the effluents comprise, in this order, the following steps:
collecting the effluents, in particular the wastewater, in a container,
optionally the addition of a flocculant,
optionally decanting,
optionally separation of the filtrate and sludges, in particular by filtration,
optionally neutralization of the filtrate, in particular removal of ammonia, by adding acid while monitoring the pH,
distillation of the filtrate, preferably in an evaporator,
optionally passage through an activated charcoal system,
reuse of the distillate in the metallizing method for example as rinsing water or as diluent of the oxidizing-reducing stock solutions or discharge to the drains.

The flocculant added to the effluents is preferably a charged organic polymer, such as those marketed by SNF FLOERGER®.

The supernatant and sludges are advantageously separated by filtration on a frit, or by overflow.

The sludges can then be removed and transported to a centre specializing in waste treatment or recycling.

The filtrate obtained can be neutralized, in particular by adding a solution of acid with normality from 0.1 N to 10 N and until the filtrate reaches a pH from 5 to 6. The acids used for neutralizing in particular the ammonia present in the filtrate are selected from hydrochloric acid, sulphuric acid, nitric acid and mixtures thereof.

Distillation of the filtrate is preferably carried out by means of an evaporator, and the filtrate is heated to a temperature from 90 to 120° C. The residue that remains at the bottom of the reboiler at the end of distillation is removed and is taken to a centre specializing in waste treatment or recycling. The distilled water can be reused in the metallizing method, and in particular for diluting the stock solutions as well as for the rinsing and wetting steps.

The method according to the invention has many advantages.

Firstly, the method of the invention is simplified from an industrial standpoint, relative to the methods of the prior art. There can also be a saving of paints. Moreover, the effluents discarded by the method, which represent, on an industrial scale, more than a tonne per day, are treated and reused in the method. The distilled water leaving the treatment module is pure and can be used as it is for diluting the stock solutions of oxidizer and reducing agent, as well as for rinsing and wetting. This is an appreciable advantage, on the one hand, from an economic standpoint, as the consumption of water is reduced significantly and, on the other hand, from an ecological standpoint, as there is a considerable decrease in the amount of waste to be disposed of. It is important to point out that industrial water cannot be used in the method, and that a purification step would be necessary if the method did not have a module for the treatment of effluents and the purification of wastewater. Moreover, the method uses concentrated stock solutions, which are diluted in situ just before metallization. The volume of stock solutions to be transported is therefore less than if the solutions were already diluted, which reduces costs, in particular for transport.

Moreover, the amounts of reducing agent used are less than the permitted norm (ISO 14001), and as this compound is toxic to the environment, reducing the amounts used represents an important ecological advantage.

The invention will be better understood on reading the following description of examples of the manufacture of mirrors, referring to the attached drawings in which:

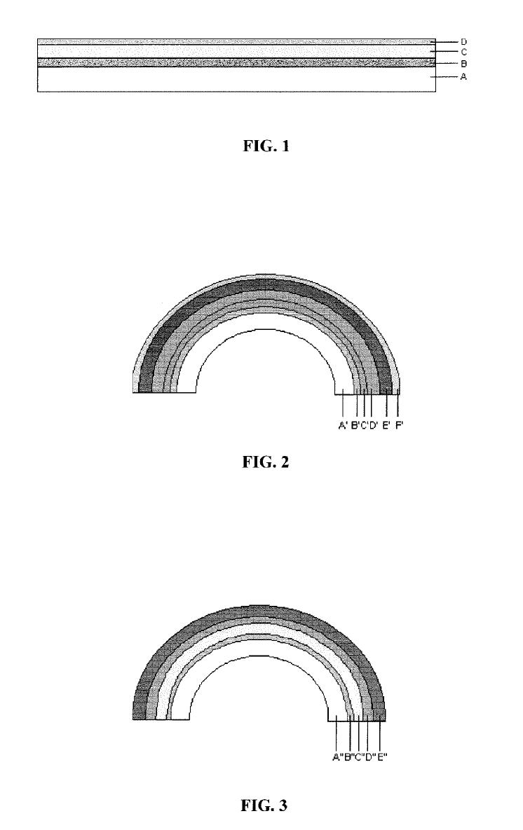

FIG. 1 shows a diagram, not to scale, of a sectional view of a mirror according to a first embodiment of the invention,

FIG. 2 shows a diagram, not to scale, of a sectional view of a mirror according to a second embodiment of the invention,

FIG. 3 shows a diagram, not to scale, of a sectional view of a mirror according to a third embodiment of the invention.

In FIG. 1, the mirror consists of 4 layers A, B, C and D. Layer A represents the rigid glass substrate. Layer B is the silver coating of thickness e_{Ag}. Layer C is the protective layer based on at least one metal other than silver, for example a layer of nickel-boron alloy of thickness e_{M} equal to 2 e_{Ag}, and layer D is the optional layer of finishing paint, for example an alkyd paint marketed by the company FENZI®.

In FIG. 2, the mirror consists of 6 layers called A′, B′, C′, D′, E′ and F′. A′ represents the rigid glass substrate, of parabolic shape. Layer B′ is the silver coating of thickness e_{Ag}. Layers C′, D′, E′ represent a three-component protective layer, based on at least one metal other than silver, for example a nickel-boron/copper/nickel-boron three-component layer with a total thickness e_{M} equal to 2.5 e_{Ag}, and layer F′ is the optional layer of finishing paint, for example an alkyd paint marketed by the company FENZI®.

In FIG. 3, the mirror consists of 5 layers called A″, B″ and C″, D″ and E″. A″ represents the rigid glass substrate, of parabolic shape. Layer B″ is the silver coating of thickness e_{Ag}. Layers C″, D″ and E″ represent a three-component protective layer, based on at least one metal other than silver, for example a Sn/Cu/Zn three-component layer with a total thickness e_{M} equal to 2.5 e_{Ag}.

Experimental Section

### Examples According to the Invention:

### EXAMPLE 1

### Ag//Ni—B Mirror According to the Invention

A glass plate of dimensions 6×3 m and thickness 3 mm is placed on a conveyor advancing at a speed of 3 m/min and is subjected successively to:
sensitizing of the surface by spraying, using HVLP guns, a solution based on stannous chloride for 10 seconds,
rinsing of the sensitizing solution by spraying with water for 10 seconds, using HVLP guns,
activation of the surface by spraying, using HVLP guns, a solution based on palladium chloride for 10 seconds,
rinsing of the activating solution by spraying with water for 10 seconds, using HVLP guns,
simultaneous spraying of an aqueous solution based on silver nitrate at a concentration of 8 g/l and an aqueous solution of glucose at 50 g/l, using HVLP guns, until a silver coating of 1 g/m² is obtained,
rinsing with water for 10 seconds, by spraying using HVLP guns,
simultaneous spraying of an aqueous solution based on nickel sulphate at a concentration of 10 g/l and an aqueous solution of sodium borohydride at 7 g/l, using HVLP guns, until a layer of Ni—B of 2 g/m² is obtained,
rinsing with water for 10 seconds, by spraying using HVLP guns,
drying by alternating pulsed compressed air at 5 bar at room temperature and pulsed air at normal pressure at 40° C.

The metallized surface of the mirror thus produced is covered, using painting curtains, with a layer of alkyd paint from the company FENZI®. The minor is then heated in a heating chamber at 180° C. for 15 minutes.

An “all-metal” anticorrosion mirror 1 is thus obtained, having the following characteristics:
thickness of silver: 100 nm,
thickness of nickel-boron: 200 nm,
and for which the test results are summarized in Table 1 below.

### EXAMPLE 1a

### Ag//Ni—B Mirror According to the Invention

A glass plate of dimensions 6×3 m and thickness 3 mm is placed on a conveyor advancing at a speed of 3 m/min and is subjected successively to:
sensitizing of the surface by spraying, using HVLP guns, a solution based on stannous chloride for 10 seconds,
rinsing of the sensitizing solution by spraying with water for 10 seconds, using HVLP guns,
activating the surface by spraying, using HVLP guns, a solution based on palladium chloride for 10 seconds,
rinsing of the activating solution by spraying with water for 10 seconds, using HVLP guns,
simultaneous spraying of an aqueous solution based on silver nitrate at a concentration of 8 g/l and an aqueous solution of glucose at 50 g/l, using HVLP guns, until a silver coating of 800 mg/m² is obtained,
rinsing with water for 10 seconds, by spraying using HVLP guns,
simultaneous spraying of an aqueous solution based on nickel sulphate at a concentration of 10 g/l and an aqueous solution of potassium borohydride at 7 g/l, using HVLP guns, until a layer of Ni—B of 1.6 g/m² is obtained,
rinsing with water for 10 seconds, by spraying using HVLP guns,
drying by alternating pulsed compressed air at 5 bar at room temperature and pulsed air at normal pressure at 40° C.

The metallized surface of the mirror thus produced is covered, using painting curtains, with a layer of alkyd paint from the company FENZI®. The minor is then heated in a heating chamber at 180° C. for 15 minutes.

An “all-metal” anticorrosion mirror la is thus obtained, having the following characteristics:
thickness of silver: 80 nm,
thickness of nickel-boron: 160 nm,
and with the test results summarized in Table 1 below.

### EXAMPLE 2

### Ag//Ni—B/Cu/Ni—B Mirror According to the Invention

A glass plate of parabolic shape of dimensions 1.2×1 m and thickness 3 mm is placed on a conveyor advancing at a speed of 3 m/min and is subjected successively to:
sensitizing of the external surface of the substrate by spraying, using HVLP guns, a solution based on stannous chloride for 10 seconds,
rinsing of the sensitizing solution by spraying with water for 10 seconds, using HVLP guns,
activating the surface by spraying, using HVLP guns, a solution based on palladium chloride for 10 seconds,
rinsing of the activating solution by spraying with water for 10 seconds, using HVLP guns,
simultaneous spraying of an aqueous solution based on silver nitrate at a concentration of 8 g/l and an aqueous solution of glucose at 50 g/l, using HVLP guns, until a silver coating of 1 g/m² is obtained,
rinsing with water for 10 seconds, by spraying using HVLP guns,
simultaneous spraying of an aqueous solution based on nickel sulphate at a concentration of 10 g/l and an aqueous solution of sodium borohydride at 7 g/l, using HVLP guns, until a layer of Ni—B of 1 g/m² is obtained,
rinsing with water for 10 seconds, by spraying using HVLP guns,
simultaneous spraying of an aqueous solution based on copper sulphate at a concentration of 10 g/l and an aqueous solution of hydrazine at 7 g/l, using HVLP guns, until a layer of Cu of 0.5 g/m² is obtained,
rinsing with water for 10 seconds, by spraying using HVLP guns,
simultaneous spraying of an aqueous solution based on nickel sulphate at a concentration of 10 g/l and an aqueous solution of sodium borohydride at 7 g/l, using HVLP guns, until a layer of Ni—B of 1 g/m² is obtained,
rinsing with water for 10 seconds, by spraying using HVLP guns,
drying by alternating pulsed compressed air at 5 bar at room temperature and pulsed air at normal pressure at 40° C.

The metallized surface of the mirror thus produced is covered, using painting curtains, with a layer of alkyd paint from the company FENZI®. The minor is then heated in a heating chamber at 180° C. for 15 minutes.

An “all-metal” anticorrosion mirror 2 is thus obtained, having the following characteristics:
thickness of silver: 100 nm,
total thickness of the Ni—B/Cu/Ni—B protective layer: 250 nm,
and with the test results summarized in Table 1 below.

### EXAMPLE 3

### Ag//Sn//Zn//Cu Mirror According to the Invention

A glass plate of parabolic shape of dimensions 1.2×1 m and thickness 3 mm is placed on a conveyor advancing at a speed of 3 m/min and is subjected successively to:
sensitizing of the external surface of the substrate by spraying, using HVLP guns, a solution based on stannous chloride for 10 seconds,
rinsing of the sensitizing solution by spraying with water for 10 seconds, using HVLP guns,
activating the surface by spraying, using HVLP guns, a solution based on palladium chloride for 10 seconds,
rinsing of the activating solution by spraying with water for 10 seconds, using HVLP guns,
simultaneous spraying of an aqueous solution based on silver nitrate at a concentration of 8 g/l and an aqueous solution of glucose at 50 g/l, using HVLP guns, until a silver coating of 1 g/m² is obtained,
rinsing with water for 10 seconds, by spraying using HVLP guns,
simultaneous spraying of an aqueous solution based on tin chloride at a concentration of 2 g/l and an aqueous solution of hydrazine at 7 g/l, using HVLP guns, until a layer of Sn of 1 g/m² is obtained,
rinsing with water for 10 seconds, by spraying using HVLP guns,
simultaneous spraying of an aqueous solution based on copper sulphate at a concentration of 10 g/l and an aqueous solution of hydrazine at 7 g/l, using HVLP guns, until a layer of Cu of 0.5 g/m² is obtained,
rinsing with water for 10 seconds, by spraying using HVLP guns,
simultaneous spraying of an aqueous solution based on zinc sulphate at a concentration of 10 g/l and an aqueous solution of potassium borohydride at 10 g/l, using HVLP guns until a layer of Zn of 1 g/m² is obtained,
rinsing with water for 10 seconds, by spraying using HVLP guns,
drying by alternating pulsed compressed air at 5 bar at room temperature and pulsed air at normal pressure at 40° C.

An anticorrosion mirror 3 is thus obtained, having the following characteristics:
thickness of silver: 100 nm,
total thickness Sn/Cu/Zn: 250 nm,
and with the test results summarized in Table 1 below.

### COMPARATIVE EXAMPLE

### “All-Paint” Mirror

A glass plate of dimensions 6×3 m and thickness 3 mm cm is subjected successively to:
sensitizing of the external surface of the substrate by spraying, using HVLP guns, a solution based on stannous chloride for 10 seconds,
rinsing of the sensitizing solution by spraying with water for 10 seconds, using HVLP guns,
activating the surface by spraying, using HVLP guns, a solution based on palladium chloride for 10 seconds,
rinsing of the activating solution by spraying with water for 10 seconds, using HVLP guns,
simultaneous spraying of an aqueous solution based on silver nitrate at a concentration of 8 g/l and an aqueous solution of glucose at 50 g/l, using HVLP guns, until a silver coating of 1 g/m² is obtained,
drying by alternating pulsed compressed air at 5 bar at room temperature and pulsed air at normal pressure at 40° C.

The metallized surface of the mirror thus produced is covered, using painting curtains, with a layer of alkyd paint from the company FENZI®. The minor is then heated in a heating chamber at 180° C. for 15 minutes. This last step is repeated twice.

A comparative “all-paint” mirror 1′ is thus obtained, having the following characteristics:
thickness of silver: 100 nm,
total thickness of the three layers of paint: 600 nm,
and with the test results summarized in Table 1 below.

### Description of the Tests:

### Corrosion Resistance: CASS Test:

In a chamber at 50° C., ten plates of 10 cm² with freshly cut edges of each example of mirror produced above (Examples 1, 1a, 2, 3, and comparative) are subjected to a copper acetic acid salt spray, by spraying with an aqueous solution containing 50 g/l of sodium chloride, 0.26 g/l of anhydrous CuCl₂ with a sufficient amount of glacial acetic acid so that the solution has a pH between 3.1 and 3.3. The duration of exposure of the plates is 120 hours. Each plate is then examined with a microscope to measure the distance degraded, in micrometres. The distance degraded is averaged for each mirror. For reference, above 200 μm of distance degraded, the result is not satisfactory.
The number of “spots” that appeared following the above CASS test is also examined under the microscope. For the result to be satisfactory, this number must be less than 10 per 1 dm².

### Reflectivity:

The mirrors from the examples described above are subjected to a light spectrum, scanning all visible wavelengths (400-700 nm). The light source is a 100 W halogen lamp from LOT-ORIEL. This equipment is coupled to a spectrometer for measuring absorption between 400 and 800 nm, which calculates the percentage of light reflected by the mirror.

### Test Results:

TABLE 1
Test results

| | | | | | Comparative |
|---|---|---|---|---|---|
| | Ex. 1 | Ex. 1a | Ex. 2 | Ex. 3 | example |
| CASS test | 91 | 89 | 85 | 90 | 140 |
| (μm) | | | | | |
| CASS test | =1 | <1 | =1 | <1 | 3 |
| (number of | | | | | |
| spots) | | | | | |
| Reflectivity | 92 | 92 | 94 | 93 | <90 |
| (%) | | | | | |

### Conclusion Regarding Corrosion Resistance:

According to the results obtained in the CASS test, it can be stated that the corrosion resistance of the “all-metal” mirrors according to the invention is improved relative to an “all-paint” mirror of the prior art.

### Conclusion Regarding Reflectivity:

According to the results obtained in the test of reflectivity, it can be stated that the reflectivity of the mirror of Example 1, which has a reduced thickness of silver relative to comparative Example 1a (80 nm instead of 100 nm), is equivalent to that of comparative Example 1a. This indicates that the presence of a protective metallic layer makes it possible to reduce the thickness of the layer of silver while preserving the same properties of reflectivity (better than 90%). Moreover, the reflectivity of the mirrors of the invention is improved relative to that of the mirrors of the prior art.

1. Corrosion-resistant mirror comprising:
a glass substrate,
a silver coating, of thickness e_{Ag}, deposited on at least one face of the substrate, by non-electrolytic metallization consisting of spraying on said face of the substrate at least one aerosol containing silver in cationic form (oxidizer) and at least one reducing agent, capable of converting the silver cation into metal,
at least one protective layer, based on at least one metal other than silver, deposited on the silver coating,
wherein
the silver coating has a thickness e_{Ag} between 30 and 150 nm, preferably between 50 and 120 nm,
and said protective layer:
has a thickness e_{M} such that: 0.3 e_{Ag}≦e_{M}≦5 e_{Ag}, and
is obtained by non-electrolytic metallization of the silver coating, this metallization being carried out by spraying, on the silver coating, at least one aerosol containing at least one metal, other than silver, in cationic form (oxidizer), and at least one reducing agent capable of converting the metal cation into metal,
is a monolayer of metal other than silver, in which the metal is selected from the following group: Ni, Zn, Co, Fe, Mn, Ti, Pd, Sn, Al, and binary and ternary alloys based on Ni, Co, Zn, Fe, Cu and B, or
is a multilayer of metals other than silver, in which:
the metal of each protective layer is selected from the following group: Cu, Ni, Zn, Co, Fe, Mn, Ti, Pd, Sn, Al, and binary and ternary alloys based on Ni, Co, Zn, Fe, Cu and B, and,
the metals or alloys of two successive, contiguous layers are different.

2. Mirror according to claim 1, wherein at least one protective layer additionally contains particles selected from the following group: diamond, ceramics, carbon nanotubes, metal particles, rare earth oxides, PTFE (polytetrafluoroethylene), graphite, metal oxides and mixtures thereof.

3. Mirror according to claim 1, wherein it further comprises at least one finishing layer applied on the at least one protective layer.

4. Mirror according to claim 1, wherein it has a reflectivity greater than 85%, preferably greater than 90%.

5. Non-electrolytic method for producing a corrosion-resistant mirror comprising:
optionally a step of sensitizing the surface of a glass substrate by spraying a sensitizing solution, preferably based on stannous chloride,
optionally rinsing,
optionally a step of activation of the surface of the glass substrate by spraying an activating solution, preferably based on palladium chloride,
optionally rinsing,
a step of silvering by spraying, on at least one substrate surface, at least one aerosol containing silver in cationic form (oxidizer) and at least one reducing agent, capable of converting the silver cation into metal, the silver coating thus obtained having a thickness e_{Ag} between 30 and 150 nm, preferably between 50 and 120 nm;
optionally rinsing,
optionally drying,
a step of producing at least one protective layer, based on at least one metal other than silver, of thickness between 0.3 and 5 times the thickness of the silver coating produced during the silvering step, and by spraying, on the silver-coated substrate surface, at least one aerosol containing at least one metal in cationic form (oxidizer), other than silver, and at least one reducing agent, capable of converting the metal cation into metal; said protective layer being:
either a monolayer of metal other than silver, in which the metal is selected from the following group: Ni, Zn, Co, Fe, Mn, Ti, Pd, Sn, Al, and binary and ternary alloys based on Ni, Co, Zn, Fe, Cu and B
or a multilayer of metals other than silver, in which the metal of each protective layer is selected from the following group: Cu, Ni, Zn, Co, Fe, Mn, Ti, Pd, Sn, Al, and binary and ternary alloys based on Ni, Co, Zn, Fe, Cu and B, and the metals or alloys of two successive, contiguous layers are different.

6. Method according to claim 5, wherein the step of producing the at least one protective layer based on at least one metal is carried out by simultaneous spraying on the surface, in one or more aerosols, at least one solution of metal cation(s) other than silver, and at least one solution of reducing agent(s), in one and the same phase of spraying.

7. Method according to claim 6, wherein the oxidizing solution and the reducing solution are mixed either just before formation of the spraying aerosol, or by blending an aerosol produced from the oxidizing solution and an aerosol produced from the reducing solution, preferably before coming into contact with the metallized substrate surface.

8. Method according to claim 5, wherein the step of producing at least one protective layer based on at least one metal is carried out by alternate spraying of reducing solution(s) and oxidizing solution(s) of metal cations.

9. Method according to claim 5, wherein it further comprises a step of producing at least one finishing layer, preferably of paint.

10. A method of use of a corrosion-resistant mirror as defined in any one of claims 1 to 4 for the application thereof in solar energy collection.

11. A method of use of a corrosion-resistant mirror for collecting solar energy, wherein said mirror is produced according to the method of any one of claims 5 to 9.
